(19) United States
(12) Patent Application Publication
(10) Pub. No.: US 2001/0056143 A1
(43) Pub. Date: Dec. 27, 2001

(54) TEMPORARY PROTECTION OF PLASTIC ARTICLES AGAINST ELECTROSTATIC CHARGING

(76) Inventors: RAMONA BAUMGAERTEL, STUTTGART (DE); WALTER MAIER, STUTTGART (DE); JUERGEN ORTMEIER, KIRCHHEIM (DE)

Correspondence Address: BAKER & BOTTS, 30 ROCKEFELLER PLAZA, NEW YORK, NY, 10112

(21) Appl. No.: 09/348,641

(22) Filed: Jul. 6, 1999

(30) Foreign Application Priority Data
Jul. 6, 1998 (DE) 19830176.6

(51) Int. Cl. C08K 3/02; B05D 1/00

(52) U.S. Cl. 524/364; 427/155

(57) ABSTRACT

In a process for the temporary protection of plastic articles, particularly plastic mouldings, against electrostatic charging and a contamination or dirtying associated therewith, the plastic article is at least partly provided with a coating, which contains an antistatic and which can be washed off with water and/or at least one organic solvent. The antistatic is in particular an electrically conductive, organic polymer. The coating is in particular applied to the plastic article in the form of a solution. The invention also covers a composition, particularly a solution, which contains at least one antistatic and at least one solvent. The antistatic is in particular an electrically conductive, organic polymer, whilst the solvent is in particular a mixture of water and organic solvents.

The invention relates to a process for the temporary protection of plastic articles against electrostatic charging and an associated dirtying, together with a composition usable in such a process.

As is known, plastics suffer from the disadvantageous characteristic of attracting and retaining by electrostatic charging particles of dust and dirt. The resulting dirtying or contamination of plastic surfaces can frequently not be completely removed even by thorough cleaning. This more particularly applies if, e.g. in a washing process, water-based detergents are used.

The contamination and impurities remaining on the plastic surface are in particular unacceptable if the plastic article in question has to be subsequently painted. Particularly in those cases where the plastic article has to be stored prior to painting and possibly even over a long period, the paint obtained can have an inadequate quality. This inadequate quality can firstly be made apparent by the optical appearance, because, as a function of the paint structure, painting principle or geometry of the plastic article, the residual dirtying effects are made visible and remain on the painted article. In addition, the inadequate quality can be made apparent by the fact that the paint coating does not or does not permanently adhere to the plastic article.

The aforementioned problem e.g. arises when painting plastic motor vehicle components, which are subject to rapid electrostatic charging during handling and consequently permanently carry dust and dirt particles on their surfaces. Particularly after prolonged storage of the plastic components prior to painting, it is impossible to completely remove such contamination. When painting on an industrial scale, particularly in mass production, there is regularly a pretreatment carried out in washers, e.g. so-called power washers. However, they are unable to remove in a completely satisfactory manner the aforementioned contamination.

The object of the invention is to remove or at least clearly reduce the problems arising when painting plastic articles caused by electrostatic charging and the resultant contamination. In particular, a suitable process for the protection of plastic articles against electrostatic charging and the resulting contamination is to be made available. A further aim of the invention is to provide the necessary agents.

These and further objects of the invention are solved by the process having the features of claim 1. Preferred developments of this process are revealed in the dependent claims 2 to 13. The invention also covers a composition having the features of claim 14, whose special developments are defined in the dependent claims 15 to 23. By reference, the wording of all the claims is made into part of the content of the description.

In the inventive process for the temporary protection of plastic articles against electrostatic charging and an associated contamination, on at least part of the plastic article surface is applied a coating. The latter contains at least one antistatic agent and can be washed off with water and/or at least one organic solvent. This process leads to the application to the plastic surface of an electrically conductive protective coating, so as to dissipate the charge resulting from electrostatic charging and consequently preventing or at least significantly reducing the contamination resulting from the attachment of dust and dirt particles. Unlike in the known electrostatic coatings, according to the invention the coating can be washed off with water and/or organic solvents, in order to permit a further treatment, finishing, etc. of the plastic article or its surface. Thus, the invention does not aim at obtaining a permanent, i.e. permanently water and/or solvent-resistant adhesion of the coating.

The method by which the electrically conductive coating is applied is not critical in the invention. It can fundamentally take place using all conventional coating methods, such as e.g. brushing, spraying, rolling, spin coating, etc.

According to the process of the invention it is possible to coat the most varied plastic articles from the most varied plastics materials. Thus, they can e.g. be domestic or electronic appliances, e.g. computer housings, etc. The plastic articles are preferably motor vehicle components, particularly bumpers, side mirrors, door handles, inner lining elements, etc. These and further plastic articles frequently undergo further treatment or finishing and in particular at least one painting process can be provided for decorative or protective purposes. As is known, e.g. bumpers, side mirrors and other vehicle components are painted, preferably in accordance with the external paint colour of the vehicle. When using the process according to the invention the aforementioned advantages occur, independently of whether during the painting operation use was made of a liquid paint based on organic solvents, a water-based liquid paint or a powder paint.

As has already been stated, the process according to the invention can be used in the case of numerous conventional plastics materials. Optionally, prior to the application of the temporary antistatic coating, pretreatment steps can be performed, such as e.g. are conventional when coating individual plastics materials, e.g. cleaning steps or a so-called corona treatment. The process according to the invention can in particular be used for plastics materials such as are employed in motor vehicle building. In exemplified manner only reference is made to polypropylene PP, polyethylene PE, polycarbonate PC and ethylene-propylene-diene terpolymers EPDM.

In the process according to the invention the coating can be applied preferably immediately or shortly after the manufacture of the plastic article. In this case the plastic article is protected against dirtying during transportation from the place or company of manufacture to the further treatment company or place. The removal, i.e. dissolving or washing off of the coating then takes place preferably immediately or shortly before the further treatment and in particular immediately before painting. In all cases, but in particular in those where the plastic article is painted, the dissolving or washing off of the coating preferably takes place with the aid of water-based detergents. This makes it possible to take account of environmental standpoints and also use existing washers, such as are available in connection with the mass painting of plastic car components.

In principle, in the process according to the invention it is possible to use all known antistatics, provided that the resulting coating can be washed off with water and/or organic solvents. The antistatic agent is in particular an electrically conductive, organic polymer. Particular reference is made to electrically conductive polyheterocycles and, apart from polypyrroles and polyanilines, use is preferably made of so-called polythiophenes. It is also possible to use polymers which, apart from the electrically conductive polymer, particularly the polyheterocycles, contain further (conductive or non-conductive) polymers. A preferred, electrically conductive polymer can be gathered from the examples.

In the preferred developments of the process according to the invention the coating is applied to the plastic article in the form of a solution. This solution contains the antistatic, i.e. in particular the polymer, and at least one solvent. As has already been stated, the process used for applying the solution to the plastic surface is not critical. The anti- static coating forms as a result of the evaporation or vaporizing of the solvent. This drying process can take place at ambient temperature, but in particular when also applying higher temperatures, the characteristics of the coating obtained being improved and the drying times reduced.

The solvent can be water, organic solvents or mixtures of water and organic solvents. The organic solvents are in particular polar, organic solvents, which are correspondingly at least partly miscible with water. Particular reference is made to aliphatic alcohols, such as ethanol and isopropanol, acetone and N-methyl-pyrrolidone.

In further preferred embodiments of the process according to the invention, the solvent is constituted by a mixture of water and at least one organic solvent. These are e.g. mixtures of isopropanol and water or mixtures of isopropanol, water and N-methyl-pyrrolidone.

The water to organic solvent weight ratio is preferably 50:1 to 1:50 and within the aforementioned range preferred ranges are 50:1 to 1:1 and in particular 20:1 to 5:1.

If organic solvents are present in the solution used, the total organic solvent proportion is preferably at least 2 and in particular at least 4 wt. %, based on the total weight of the solution. The aim is to keep the organic solvent proportion in the solution low for known reasons and correspondingly the water proportion in the solution should be high.

The antistatic quantity in the solution must be sufficiently high to ensure that the coating applied to the plastic article reliably dissipates the electrostatic electricity. Particularly when using electrically conductive, organic polymers, such as polythiophenes or polythiophene-containing polymers, comparatively small quantities are adequate and are sought for cost reasons. In the case of conventional applications, surface resistance values are obtained of less than 10¹⁰ and in particular less than 10⁶ ohm/surface element. Thus, the solution used for coating purposes contains the antistatic preferably in a quantity of less than 5 and in particular less than 1 wt. %, based on the total weight of the solution. In a further preferred manner, the antistatic is contained in a quantity of less than 0.5, particularly between 0.01 and 0.1 wt. %.

According to a further development of the inventive process use is made of a coating solution, which additionally contains at least one additive. The additives are preferably so-called thickeners or priming wetters. The latter can serve to improve the processability of the solution and the adhesion of the coating obtained. It is fundamentally possible to use all thickeners and priming wetters known from paint technology. As a further additive use can e.g. be made of those which reduce or prevent foaming or frothing, when the coating is washed off prior to the further treatment of the plastic article. Such a foaming is in particular undesired in washers, such as are used in industrial plants, e.g. in the painting of plastic articles. The total quantity of additives in the solution is preferably less than 5 and in particular less than 1 wt. %, based on the total weight of the solution.

It is desirable to keep the proportion of additives and solids in general as low as possible in order not to burden the washing process or corresponding washers with solids. Thus, in the invention, preferably no use is made of (organic) binders.

Particular reference is made to embodiments of the inventive process, in which for the production of the antistatic coating use is made of a solution, which contains the following constituents:

at least one antistatic in a (total) quantity between 0.01 and 1 wt. %, preferably in a quantity between 0.01 and 0.1 wt. %,

water in a quantity of at least 50 wt. %, preferably in a quantity between 60 and 90 wt. %,

at least one additive in a (total) quantity between 0 and 5 wt. %, preferably in a quantity between 1 and 3 wt. % and

at least one organic solvent as the residue,

in which the weight percentages are in each case based on the total weight of the solution.

In addition to the described process, the invention also covers a composition for the temporary protection of plastic articles, particularly plastic mouldings, against electrostatic charging and an associated dirtying or contamination, which contains at least one antistatic and at least one solvent. The antistatic can in particular be an electrically conductive, organic polymer.

The composition is in particular in the form of a solution, as has been described in detail in conjunction with the inventive process. With regards to the characteristics and features of this solution, i.e. particularly the nature and quantities of antistatic (polymer), solvents (water, organic solvents, mixtures), additives, etc., express reference is made to the description given hereinbefore.

Apart from solutions, the inventive composition can also be constituted e.g. by dispersions or emulsions for the purpose of preparing the anti-static coating.

Finally, the invention also covers the use of a composition, particularly a solution, which contains at least one antistatic, in particular an electrically, organic polymer and at least one solvent, for the temporary protection of plastic articles, particularly plastic mouldings, against electrostatic charging and the contamination associated therewith.

In accordance with the use according to the invention, on at least part of its surface the plastic article is provided with a coating formed from the composition and this in particular takes place immediately or shortly after the production of the plastic article. The coating obtained, particularly prior to a subsequent treatment, such as a painting process, is washed off with water and/or at least one organic solvent. With regards to the features and characteristics of the composition used, particularly the solution used, express reference is made to the previous description.

The described and further features of the invention can be gathered from the following examples in conjunction with the claims. The individual features can be implemented singly or in the form of combinations.

### EXAMPLES

A polythiophene-containing polymer is used as the antistatic in the preparation of two compositions according to the invention. It is in the form of the product Baytron P of Bayer AG. The chemical name of this product is polyethylene dioxythiophene polystyrene sulphonate. Baytron P is an approximately 1.3 wt. % aqueous dispersion of the electrically conductive polythiophene-containing polymer.

The two solutions are prepared in such a way that initially the organic solvent and optionally water and additives are placed in a dissolver and then the Baytron P is added, accompanied by stirring. The solutions are prepared at room temperature.

The two solutions (A) and (B) have the following composition:

| Solution A | wt. % |
|---|---|
| N-methyl pyrrolidone | 4.6 |
| Isopropanol | 93.4 |
| Baytron P | 2 |
| (Water from Baytron P) | (approx. 1.97) |

| Solution B | wt. % |
|---|---|
| N-methyl pyrrolidone | 1.5 |
| Isopropanol | 30.5 |
| Water | 64 |
| Additive (wetting aid - DuPont | 0.2 |
| Zonyl FS 300 surfactant) | |
| Baytron P | 3.8 |
| (Water from Baytron P) | (approx. 3.75) |

For the preparation of an antistatic coating according to the inventive process, solutions A and B are in each case applied to the surface of a polycarbonate car bumper. This application can take place in simple manner by brushing on or dipping. The coatings obtained are dried for 5 minutes at 80° C. This gives largely colourless, difficultly visible coatings, which in each case have an adequately low surface resistance/surface element in the megaohm range.

After storing for several days in an environment with high dust percentages, the coatings can be easily washed off using a water-based cleaning solution (e.g. commercial surfactant solutions). After drying clean bumper surfaces are obtained, which are free from dust and dirt particles. Subsequent painting leads to good adhering paint coatings, whose surfaces have the desired optical characteristics.

1. Process for the temporary protection of plastic articles, particularly plastic mouldings, against electrostatic charging and an associated contamination, the plastic article being at least partly provided with a coating, which contains at least one antistatic and which can be washed off with water, or with at least one organic solvent, or with mixtures of water and at least one organic solvent.

2. Process according to claim 1, wherein the plastic articles are motor vehicle components.

3. Process according to claim 1, wherein the plastic articles are to be painted after washing off the coating.

4. Process according to claim 3, wherein the coating is washed off immediately prior to the painting process and washing off takes place with the aid of water-based detergents.

5. Process according to claim 1, wherein the antistatic is an electrically conductive, organic polymer.

6. Process according to claim 5, wherein the polymer is a polythiophene or a polythiophene-containing polymer.

7. Process according to claim 1, wherein the coating is applied to the plastic article in the form of a solution, which contains the antistatic and at least one solvent.

8. Process according to claim 7, wherein the solvent is at least one of the group consisting of water and organic solvents or mixtures thereof.

9. Process according to claim 8, wherein use is made of a mixture of water and at least one organic solvent, the water to organic solvent weight ratio being 50:1 to 1:50.

10. Process according to claim 7, wherein organic solvents are contained in the solution in a quantity of at least 2 wt. %, based on the total weight of the solution.

11. Process according to claim 7, wherein the antistatic is contained in the solution in a quantity of less than 5 wt. %, based on the total weight of the solution.

12. Process according to claim 11, wherein the antistatic is contained in the solution in a quantity between 0.01 and 0.1 wt. %, based on the total weight of the solution.

13. Process according to claim 7, wherein at least one additive is contained in the solution in a quantity of less than 5 wt. %, based on the total weight of the solution.

14. Composition for the temporary protection of plastic articles, particularly plastic mouldings, against electrostatic charging and an associated contamination, containing at least one electrically conductive, organic polymer, and at least one solvent.

15. Composition according to claim 14, wherein the anti-static is a polythiophene or polythiophene-containing polymer.

16. Composition according to claim 14, wherein the polymer is contained in the composition in a quantity of less than 5 wt. %, based on the total weight of the composition.

17. Composition according to claim 16, wherein the polymer is contained in the composition in a quantity between 0.01 and 0.1 wt. %, based on the total weight of the composition.

18. Composition according to claim 14, wherein the solvent is water or at least one organic solvent.

19. Composition according to claim 14, wherein the solvent is a mixture of water and at least one organic solvent, which is at least partly miscible with water.

20. Composition according to claim 19, wherein water and organic solvent are present in a weight ratio of 50:1 to 1:50.

21. Composition according to claim 14, wherein the organic solvent is present in the composition in a quantity of at least 2 wt. %, based on the total weight of the composition.

22. Composition according to claim 14, wherein at least one additive is present in the composition in a total quantity of less than 5 wt. %, based on the total weight of the composition.

23. Composition according to claim 14 containing
at least one antistatic in a quantity between 0.01 and 1 wt. %,
water in a quantity between 60 and 90 wt. %,
at least one additive in a quantity between 0 and 5 wt. %, and
at least one organic solvent as the residue,
the weight percentages in each case relating to the total weight of the composition.
